(19) United States
(12) Patent Application Publication
(10) Pub. No.: US 2012/0046996 A1
(43) Pub. Date: Feb. 23, 2012

(54) UNIFIED DATA MANAGEMENT PLATFORM

(76) Inventors: Vishal Shah, Cupertino, CA (US); Yi Mao, Cupertino, CA (US); Songting Chen, San Jose, CA (US); Dominic Bennett, Los Altos, CA (US); Xuhui Shao, Palo Alto, CA (US)

(21) Appl. No.: 13/206,416

(22) Filed: Aug. 9, 2011

Related U.S. Application Data
(60) Provisional application No. 61/374,544, filed on Aug. 17, 2010.

(51) Int. Cl. G06Q 10/00; G06F 17/30; G06Q 30/00

(52) U.S. Cl. 705/7.33; 705/14.45; 707/602; 707/E17.107; 707/E17.044

(57) ABSTRACT

A unified data management platform creates audience segments by combining proprietary and third party data, assists in determining what data to buy and how to manage all aspects of third party purchased data, controls data permissions by client, tracks data utilization, and attributes and reports data cost. The platform provides solutions that address how to leverage custom audience segments across multiple demand side platforms (DSPs) and multiple media channels, such as display, video, mobile, digital TV, and digital-out-of-home, and provides approaches that allow management of all aspects of Internet advertising from a custom domain.

### CROSS REFERENCE TO RELATED APPLICATIONS

This application claims priority to U.S. provisional patent application Ser. No. 61/374,544, filed Aug. 17, 2010, which application is incorporated herein in its entirety by this reference thereto.

### BACKGROUND OF THE INVENTION

1. Technical Field

The invention relates to advertising. More particularly, the invention relates to a unified data management platform.

2. Description of the Background Art

The Internet is quickly becoming a primary source for providing media. More news is now read online than in print media. Videos and television shows are increasingly watched through online applications, such as Hulu, Netflix, and YouTube.

Although the system of advertising in print media has been well-established for centuries, the rules for online advertising are still being developed. As users demand instant access to entertainment their patience for advertisements rapidly dwindles. If a user is forced to watch a pre-roll before a video is displayed, for example, the user may simply click on another window or walk away from the display screen until the advertisement is gone. If users are not watching the advertisement, the publisher is not receiving the maximum advertising revenue.

Various innovations with regard to Internet-based advertising have well addressed some of these concerns. See, for example, U.S. patent application Ser. No. 12/617,590, Segment Optimization for Targeted Advertising and U.S. patent application Ser. No. 12/410,400, Predicting User Response to Advertisements, the entirety of each of which is incorporated herein by this reference thereto.

However, there is yet room for improvement. The state of the art does not adequately address such issues as creating audience segments by combining proprietary and third party data, determining what data to buy, how to manage all aspects of third party purchased data, controlling data permissions by client, tracking data utilization, and attributing and reporting data cost. Further, there is no present solution that addresses how to leverage custom audience segments across multiple demand side platforms (DSPs) and multiple media channels, such as display, video, mobile, digital TV, and digital-out-of-home. Nor is there an approach that allows management of all aspects of Internet advertising from a custom domain.

### SUMMARY OF THE INVENTION

Presently preferred embodiments of the invention address such issues as creating audience segments by combining proprietary and third party data, determining what data to buy, how to manage all aspects of third party purchased data, controlling data permissions by client, tracking data utilization, and attributing and reporting data cost. Further, embodiments of the invention provide solutions that address how to leverage custom audience segments across multiple demand side platforms (DSPs) and multiple media channels, such as display, video, mobile, digital TV, and digital-out-of-home. Further, embodiments of the invention provide approaches that allow management of all aspects of Internet advertising from a custom domain.

### BRIEF DESCRIPTION OF THE DRAWINGS

FIG. 1 is a block schematic diagram showing a data management module, data usage module, and reporting and analytics module within a unified data management platform according to an embodiment of the invention;

FIG. 2 is a more detailed block schematic diagram showing a unified data management platform according to an embodiment of the invention;

FIG. 3 is a block schematic diagram showing the incorporation of data into a unified data management platform according to an embodiment of the invention;

FIG. 4 is a block schematic diagram showing a communications flow within a unified data management platform according to an embodiment of the invention;

FIG. 5 is an architectural schematic diagram showing a unified data management platform according to an embodiment of the invention;

FIG. 6 is a more detailed block schematic diagram showing a unified data management platform according to an embodiment of the invention;

FIG. 7 is a screen diagram showing the use of data within a unified data management platform according to an embodiment of the invention;

FIG. 8 is a screen diagram showing impression frequency reporting within a unified data management platform according to an embodiment of the invention;

FIG. 9 is a graphic representation of user impression frequency within a unified data management platform according to an embodiment of the invention;

FIG. 10 is a screen diagram showing income skews within a unified data management platform according to an embodiment of the invention;

FIG. 11 is a graphic representation of discovering actionable insights within a unified data management platform according to an embodiment of the invention;

FIG. 12 is a graphic representation of data attribution within a unified data management platform according to an embodiment of the invention;

FIG. 13 is a graph showing audience reach as determined with a unified data management platform according to an embodiment of the invention;

FIG. 14 is a block schematic diagram showing data pathways within a unified data management platform according to an embodiment of the invention;

FIG. 15 is a further block schematic diagram showing data pathways within a unified data management platform according to an embodiment of the invention;

FIG. 16 is a graphic representation showing attribution analysis according to an embodiment of the invention;

FIG. 17 is a time line showing an association window according to an embodiment of the invention; and

FIG. 18 is a block schematic diagram of a machine in the exemplary form of a computer system within which a set of instructions for causing the machine to perform any one of the foregoing methodologies may be executed.

### DETAILED DESCRIPTION OF THE INVENTION

Presently preferred embodiments of the invention address such issues as creating audience segments by combining proprietary data, e.g. advertiser's data, and third party data, e.g. publicly available data; determining what data to buy and how to manage all aspects of third party purchased data; controlling data permissions by client; tracking data utilization; and attributing and reporting data cost with regard to multiple sets of data having different associated costs, where each data source is credited with regard to its actual contribution to overall costs. Further, embodiments of the invention provide solutions that address how to leverage custom audience segments across multiple demand side platforms (DSPs) and multiple media channels, such as display, video, mobile, digital TV, and digital-out-of-home. Further, embodiments of the invention provide approaches that allow management of all aspects of Internet advertising from a custom, e.g. client, domain.

A key aspect of the invention is the provision of a unified data management platform (DMP) that provides such functionality as:
Data contract support: for example, cost per thousand unique users (CPMUU), cost per thousand events (CPME), cost per thousand impressions utilized (CPMU), or hybrid pricing models combining CPMUU with CPMU, or CPME with CPMU.
Integration with multiple DSPs for audience targeting: composing the audience segment manually or automatically with data and syndicating the audience segment across one or more DSPs for media buying based on that audience segment.
Data cost attribution: keeping track of all the data sources used in targeting for each ad impression, allocating and aggregating the data cost according to the respective data contract to different levels (for example, the line item, package, IO or advertiser level) in order to support billing and reporting.
Cross-media performance attribution: keeping track of all the interactions each user has engaged in across all media channels (for example, display ad impressions and clicks, search ad clicks, mobile ads, video ads, website visits, online sign-ups and online purchases) and attributing the desired advertising outcome (for example, purchases) proportionally to each media channel or its subset based on the analysis of its contribution to the outcome.
Canned reports run against event level data:
   Data partner payment reports
   Segment effectiveness
   Audience reach
Data cost estimates in audience extender or other rule-based behavior segments: estimating the total cost payable to all data providers for a given advertising campaign based on historical volumetric data and data contracts for each data source.
Data Mine query access: querying the advertising data sets (for example the advertising impression logs and the user profiles) stored in the data warehouse using query language and optimization. Data Mine is the proprietary data warehouse and query interface implemention based on U.S. patent application Ser. No. 12/751,847.
Enhanced Insights:
   Custom date ranges
   Audience segment analysis
Multi-touch, i.e. multiple event, optimization support: Allowing a client to specify their advertising objective in the form of a weighted sum of value of multiple desired user outcomes where each outcome can be a binary event (for example, user visited a specific web page) or a continuous value (for example, the total amount of the user's transaction).
Additional data input formats:
   Global user ID (GUID) synchronization
   IP address joins
   CNAME capabilities
   Server to server communication with:
Data providers
Media Providers (DSP's):
   Additional data dimensions
   Additional data collection on pixels
Automatic search query capture: allowing page-by-page or site-wide capturing of the search query that has referred the user to the advertiser or publisher's web page.
Generic/universal pixels which:
   Allow for mapping of taxonomy on the server side
   Obtain page headers, URL tags, etc
   API driven modeling and bidding
Construct models in Data Mine or other third party software: building multivariate predictive models or explanatory models (for example, used for attribution analysis described above) directly, or outputting transformed, filtered and sampled data set from Data Mine to third-party modeling software in one of the supported formats.
Push targeting details to DSPs:
   Audience definitions
   Bid amounts
   Decisioning.

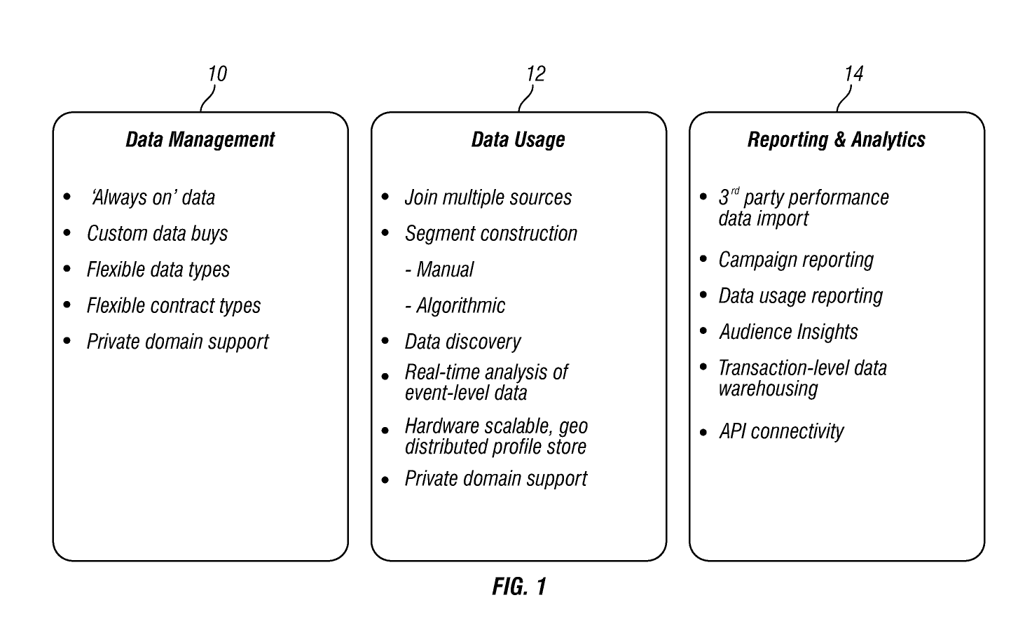

FIG. 1 is a block schematic diagram showing a data management module 10, data usage module 12, and reporting and analytics module 14 within a unified data management platform according to an embodiment of the invention. The data management module provides functionality for such features as “Always On” data, custom data buys, flexible data types, flexible contract types, and private domain support. The data usage module provides functionality for such features as the joining of multiple sources, manual and algorithmic segment construction, data discovery, real-time analysis of event-level data, a hardware scalable, geo-distributed profile store, and private domain support. The reporting and analytics module provides functionality for third party performance data imports, campaign reporting, data usage reporting, audience insights, transaction-level data warehousing, and API connectivity.

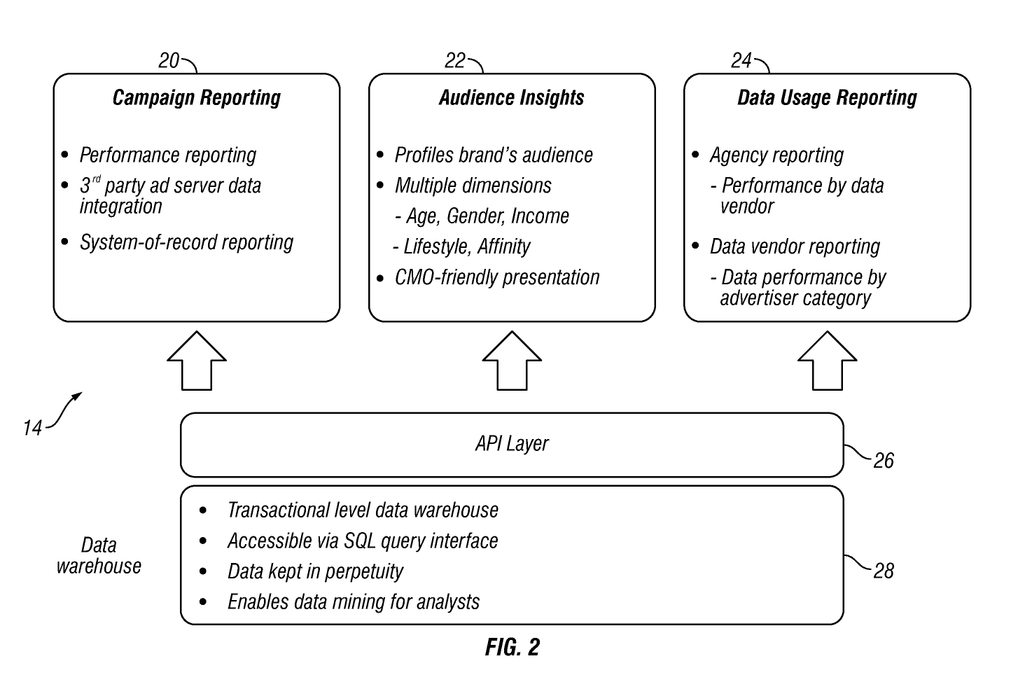

FIG. 2 is a more detailed block schematic diagram showing a unified data management platform according to an embodiment of the invention. In FIG. 2, the reporting and analytics module 14 is shown comprising a plurality of applications that, in this embodiment, include a campaign reporting application 20 that provides performance reporting, third party ad server data integration, and system-of-record reporting; an audience insights application 22 that provides profiles of a brand's performance, multiple dimensions, such as age, gender, income, lifestyle, and affinity, and CMO-friendly presentation facilities; and a data usage reporting application 24 that provides agency reporting, including performance by data vendor and data vendor reporting, including data performance by advertiser category.

The various reporting and analytics module applications communicate via and API layer 26 with a data warehouse 28. The data warehouse is a transactional level data warehouse that is accessible in this embodiment via an SQL query interface. The data warehouse keeps data in perpetuity and thus enable data mining by analysts.

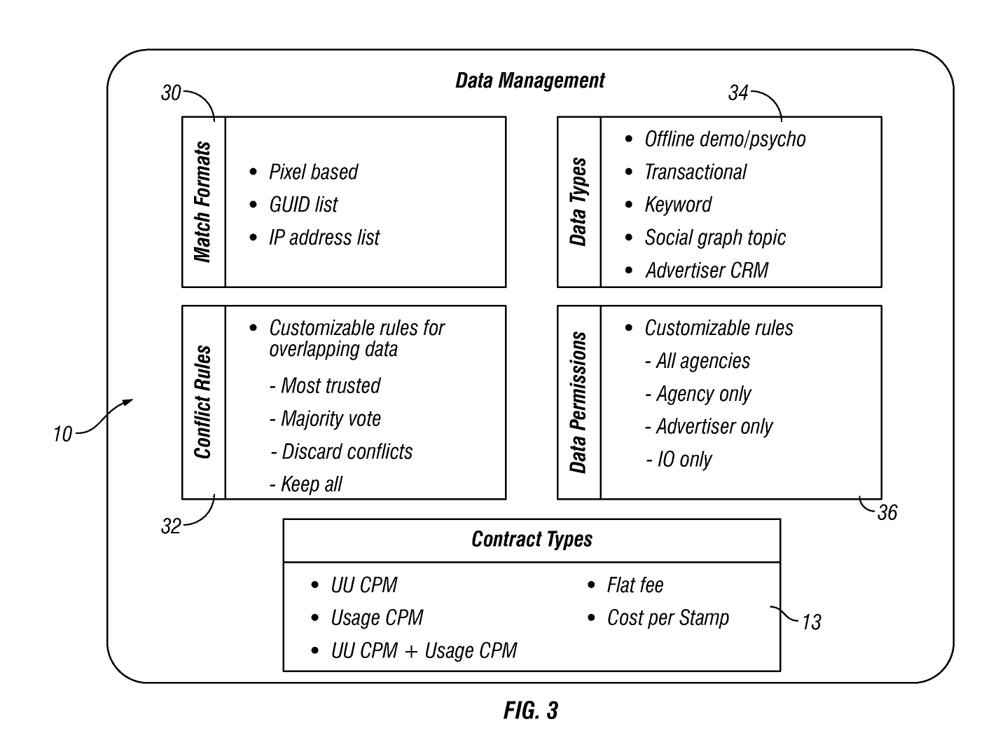

FIG. 3 is a block schematic diagram showing the incorporation of data into a unified data management platform according to an embodiment of the invention. In FIG. 3, the data management module 10 facilities are provided for matching formats 30, including pixel-based facilities, a GUID list, and an IP address list; data typing facilities 34, including offline demographics/psychological profiles, transactional data, keyword, data, social graph topics, and advertiser CRM information; a conflict rules facility 32, including customizable rules for overlapping data that include most trusted data, majority vote data, rules for discarding conflicts, and rules for keeping all data; a data permissions facility 36 that includes customizable rules which can be configured to include all agencies, agency only, advertiser only, and IO only sources; and a contract types facility 38 that includes cost per thousand unique users (CPMUU), cost per thousand events (CPME), cost per thousand impressions utilized (CPMU), flat fee, or hybrid pricing models combining CPMUU with CPMU, CPME with CPMU and etc.

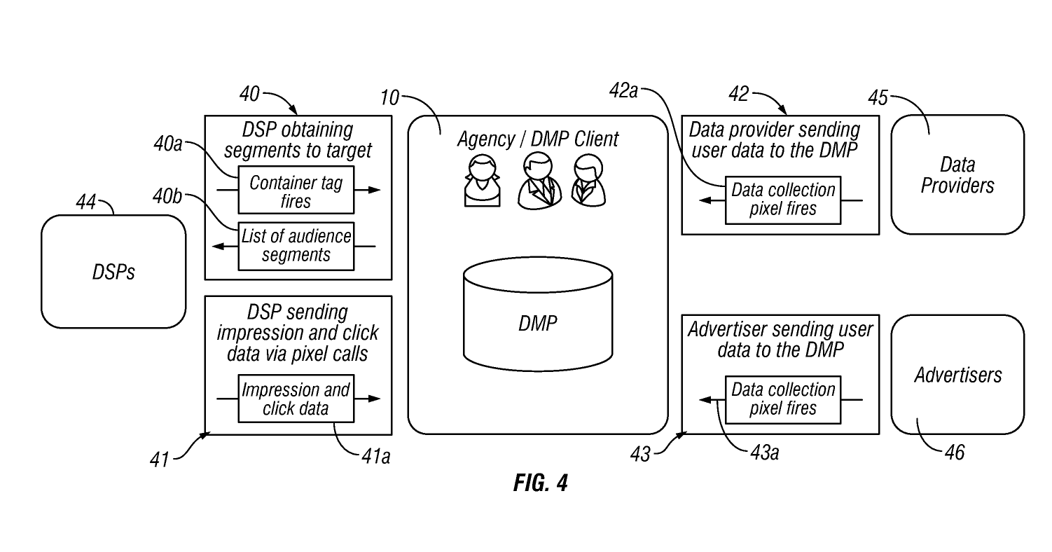

FIG. 4 is a block schematic diagram showing a communications flow within a unified data management platform according to an embodiment of the invention. In FIG. 4, the herein disclosed data management platform (DMP) 10 is shown to include access by agencies and DMP clients. The DMP is the central focal point in a unified, centralized system for overall on-line advertising management in which a plurality of demand side platforms (DSPs) 44, data providers 45, and advertisers 46 are integrated into a unitary system.

In FIG. 4, the following process flow is noted (not necessarily in this order in all embodiments):

1. The DSP s obtain segments to target 40:

Container Tag Fire (40a):
DSP needs to call the DMP to retrieve data about a user
DSP ID (Media Provider ID)
User ID (DSP's user ID)

Provider Base Pixel (40b):
The DMP responds with a list of segments that this user matches
Comma separated list of segment IDs

2. The data provider sends user data to the DMP 42:

Impression Pixel Fire (42a):
DSP provides the DMP with impression data
User ID, advertiser ID, segment ID

3. The DSP send impression and click data to the DMP via pixel calls 41:

Click Pixel Fire (41a):
DSP provides the DMP with click data
User ID, advertiser ID, segment ID

4. The data provider sends user data to the DMP 42:

Data Provider Pixel (42a):
A data provider calls the DMP with user level data
Information sent back depends on contract setup in the DMP

5. The advertisers send user data to the DMP 43:

Advertiser Data (43a):
Advertiser data is sent to the DMP to enable conversion events, other page visits, and CRM data.

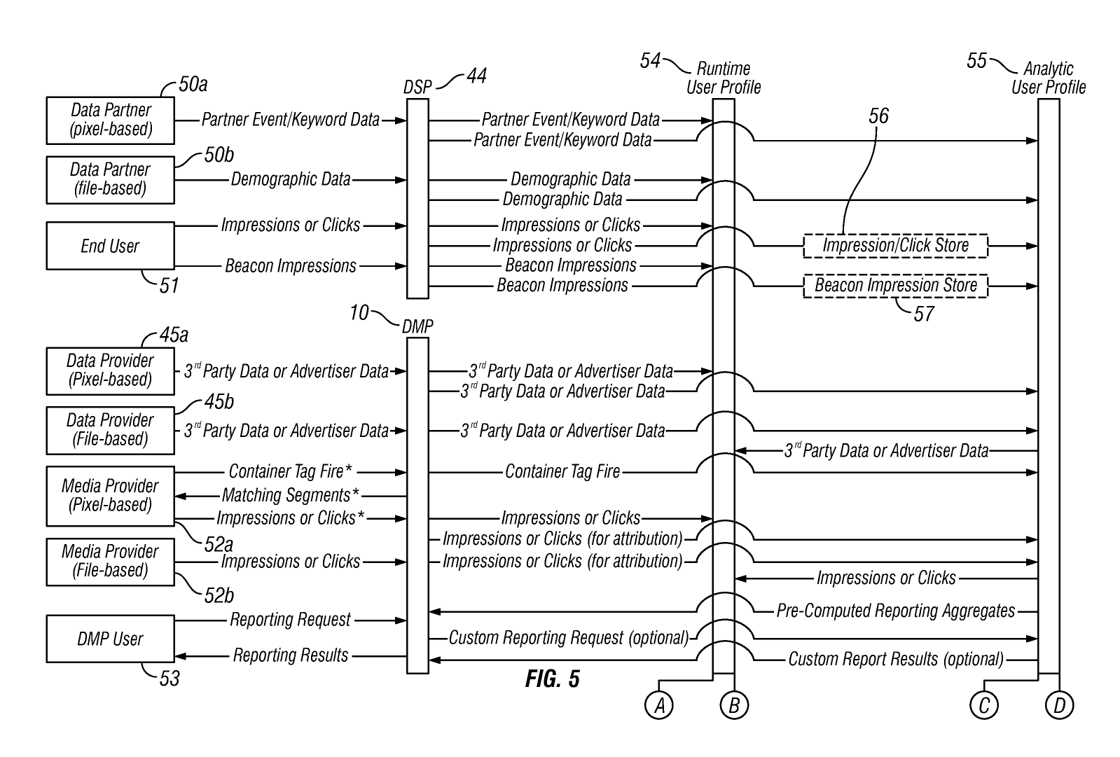

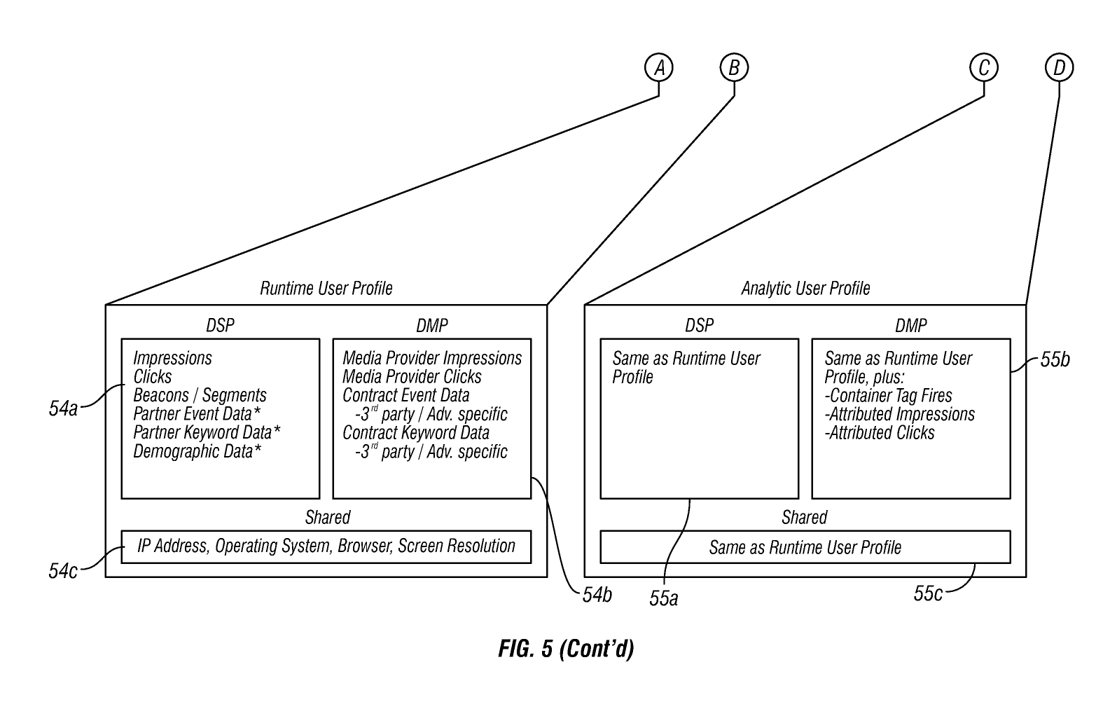

FIG. 5 is an architectural schematic diagram showing a unified data management platform according to an embodiment of the invention. FIG. 5 shows data interaction between DSPs 44 and the DMP 10 relative to two data structures: the runtime user profile 54 and the analytic user profile 55.

The DSPs, which are concerned with ad serving, receive data from pixel-based partners 50a, such as partner events and keyword data; file-based partners 50b, such as demographic data; and end users 51, including impressions or clicks and Beacon impressions, which are generated when a user visits an advertiser Web site.

The DSP serves as a point of collection for this data and, in turn, populates the runtime user profile with partner event and keyword data, demographic data, impressions or clicks, and Beacon impressions. Likewise, the DSP populates the analytic user profile with partner event and keyword data, demographic data, impressions or clicks which are stored in an impression click store 56, and Beacon impressions which are stored in a Beacon impression store 57.

The DMP receives data from pixel-based data providers 45a, file-based data providers 45b, pixel-based media providers 52a, file-based media providers 52b, and DMP users, e.g. clients 53. For the DMP, the data providers can be combined and anonymized. That is, the identity of the data providers can be hidden from the media providers or any other external entities for fear of reverse engineering from competitors, for example. Examples of media providers include Google and Yahoo. The data providers route third party data and/or advertiser data to the DMP; the pixel-based media providers route container tag fires and impressions or clicks to the DMP and receive matching segment information from the DMP; the file-based media providers route clicks or impression to the DMP; and the DMP user sends reporting requests to the DMP and receives reporting responses in reply thereto.

The runtime user profile includes a DSP component 54a, which includes impressions, clicks, Beacons, segments, partner event data, partner keyword data, and demographic data; a DMP component 54b, which includes media provider impressions, media provider clicks, contract event data, such as third party and advertiser specific data, and contract keyword data, such as third party and advertiser specific data; and a shared component 54c, which includes IP address, operating system, browser, and screen resolution information.

The runtime user profile is designed to allow real-time read/write access with very low latency (for example several milliseconds) so that targeting and bidding decisions can be made in any of the real-time bidding exchanges. Targeting decision is made by evaluating all the qualifying conditions (for example, rule-based audience segments) against the data stored in the user profile and other data available in the context of the ad call (for example, contextual, geo location, time of day, etc). Bidding decision is made by executing the relevant machine learned predictive models and the governing optimization logic against the same set of data.

The analytic user profile includes a DSP component 55a, which includes the same DSP data as the runtime user profile; a DMP component 55b, which includes the same DMP data as the runtime user profile and container tag fires, attributed impressions, and attributed clicks; and a shared component 55c, which includes the same shared information as the runtime user profile.

The analytics user profile is a super-set of data available in the run-time user profile. It is stored in the Data Mine. With its non-real time asynchronous nature, it can afford to store larger amount of data per user, and also expired anonymized user data for offline analysis, learning and reporting purposes. For example, new machine learned predictive models can be built to make more accurate predictions on how much to bid for different types of ad calls on behalf of each advertisers.

The herein disclosed architecture thus provides a platform that receives such information as pixels, log files, mobile information, and television data and that provides cross channel communications to digital, mobile, IP television, and out of the home presentation devices, thus providing full ownership, self-service access to and use of such information in the client domain. In particular, The platform provides centralization of all elements of an advertising environment including user and audience data, intelligence management, self-service user features, forecasting and availability by media channel and provider, real time evaluation of segments, best media and channel mix for best return on investment optimization, customer defined, advanced analytic models for real time scoring, contract management including flexible models and multiple pricing types, customer driver attribution models and optimization. These features are provided by the platform by the platform's ability to implement horizontally scalable real time profiles, and modules for integrating all environment information to provide reporting, insights, and analytics. A more detailed description of the platform and its workings is provided below.

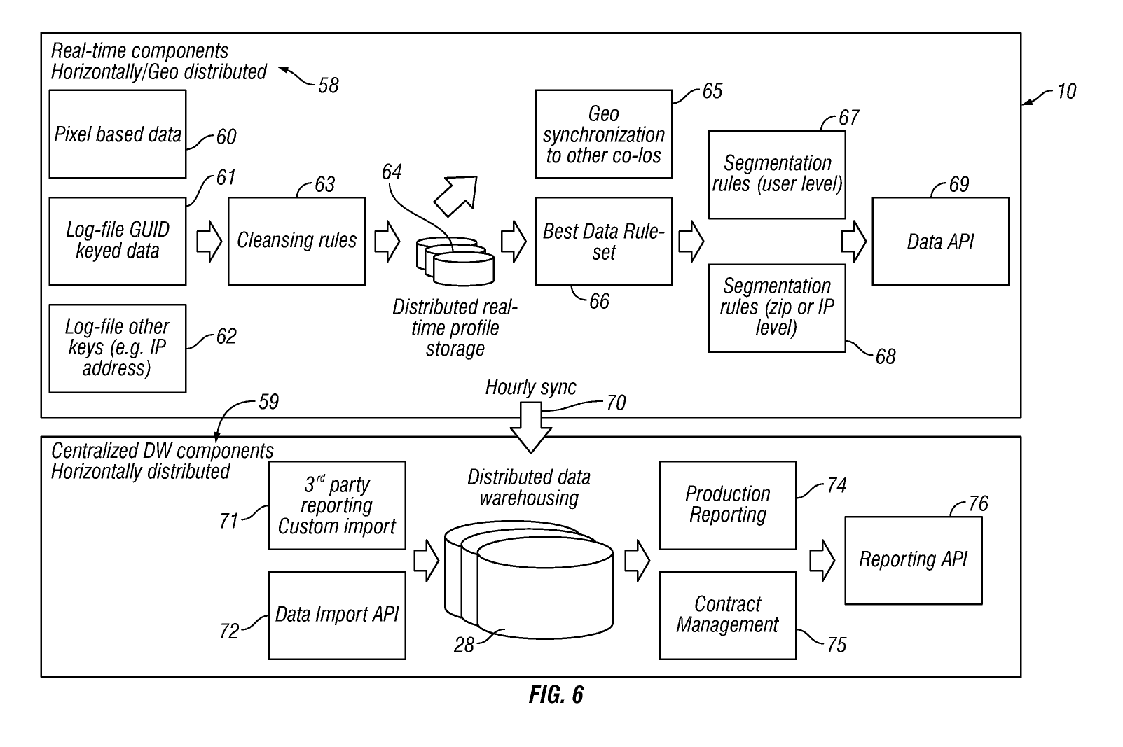

FIG. 6 is a more detailed block schematic diagram showing a unified data management platform according to an embodiment of the invention. In FIG. 6, an architecture is depicted that manages all types of data that is related to digital advertising, including third party vendor data, advertiser and customer relationship management (CRM) data, and advertising and activities from the demand side platform. FIG. 6 shows an exemplary data management platform 10, in which a set of real-time components 58 is shown horizontally geo-distributed and in which a set of centralized data components 59 is shown horizontally distributed. The real time components include modules that are configured to receive pixel-based data 60 (as discussed above), log-file GUID keyed data 61, and log-file other keys 62, e.g. IP addresses. The real-time data thus collected and received at the data management platform is processed by a cleansing rules modules 63 and then routed to distributed real-time profile storage facilities 64. Real-time profile storage is distributed geographically across multiple data centers. Each data center contains an independent copy of the real-time profile storage that is synchronized with that of other data centers. It is further partitioned within each data center across multitude of computer servers to achieve the through-put needed to handle concurrent read/write requests.

The data is then routed to modules for geo-synchronization to other data centers (also known as co-los in the trade and in the FIG. 65 and applied to a best data rule-set 66. The best data rule-set is in effect when multiple data sources have the same type of information (for example, the age of a consumer). The rules can be constructed to achieve different objectives such as selecting the most reliable source, selecting the least expensive source, or selecting all data sources to form a new result (for example by voting or intersecting of different ranges). The best data are then applied to rules modules for user level segmentation 67 and zip or IP level segmentation 68, and then output to a data API module 69. Data API 69 is typically integrated with DSPs for media buys and bidding based on the audience segments produced by the data management platform.

The real-time data are also synchronized with the data warehousing components, in this embodiment via an hourly synchronization facility 70. Those skilled in the art will appreciate that other synchronization schedules may be maintained in accordance with the invention herein.

The data warehouse components include modules configured for importing custom third party reporting 71 and a data import API 72. These report modules coordinate with distributed data warehousing modules 28 (see, also, FIG. 2) and with the data captured and processed by the real-time components to populate production reporting 74 and contract management 75 modules, which then provide reports to a reporting API layer module 26 (see, also, FIG. 2).

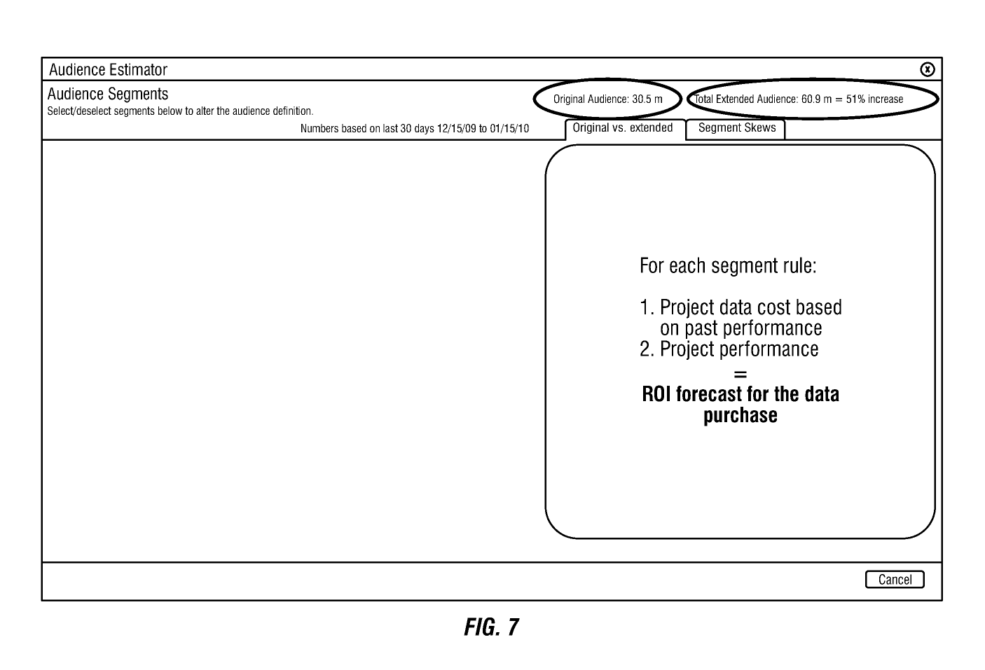

FIG. 7 is a screen diagram showing the use of data within a unified data management platform according to an embodiment of the invention. In FIG. 7, an example of a user interface is shown that allows the user to generate rules for segmentation. Those skilled in the art will appreciate that other types of rules can be generated, for example, by not by way of limitation. The unified nature of the data management platform allows the user to combine data from all sources, generate rules, and examine the firing of these rules. See, for example, Segment Optimization for Targeted Advertising, U.S. patent application Ser. No. 12/617,590.

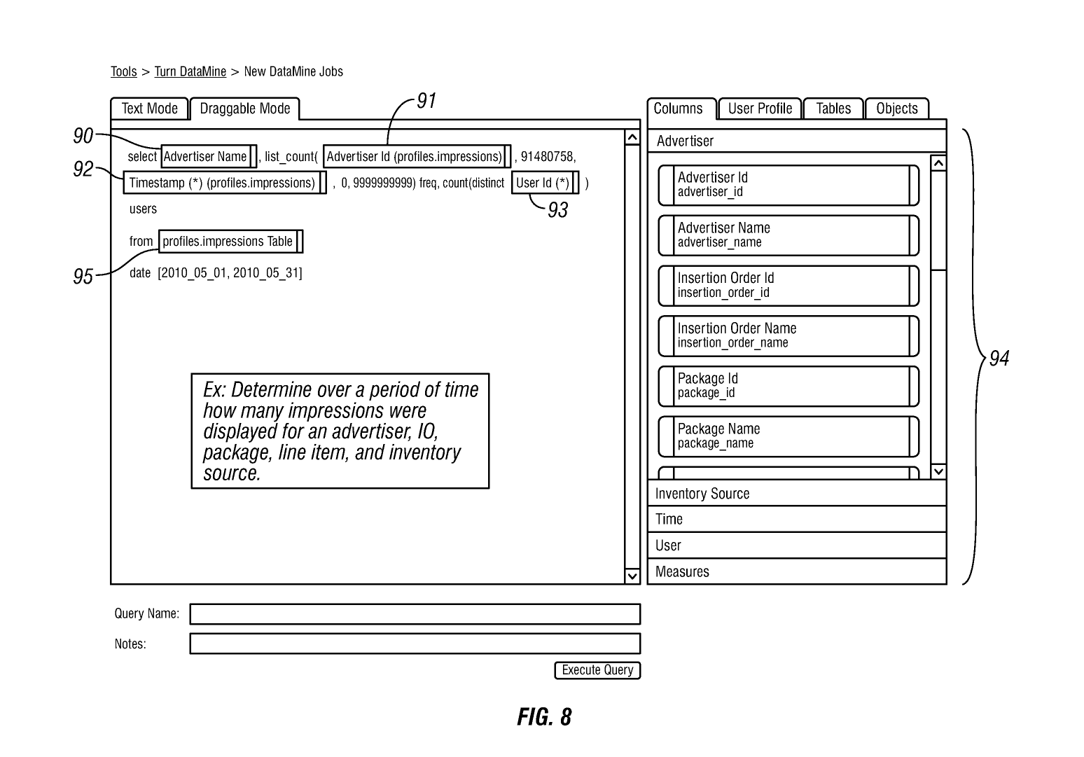

FIG. 8 is a screen diagram showing impression frequency reporting within a unified data management platform according to an embodiment of the invention. In FIG. 8, a user interface is shown in which a specific rule is generated to produce a report that shows impression frequency. The user selects the advertiser name 90, advertiser ID 91, timestamp 92, a data source 95 (in this example, the profiles impressions table, and the user ID 93. Further parameters are selected in a dialog 94 which, in this example, include advertiser, inventory source, time, user, and measures values. In FIG. 8, the advertiser pull-down has been configured to select such information as advertiser ID, advertiser name, insertion order ID, insertion order name, package ID, and package name.

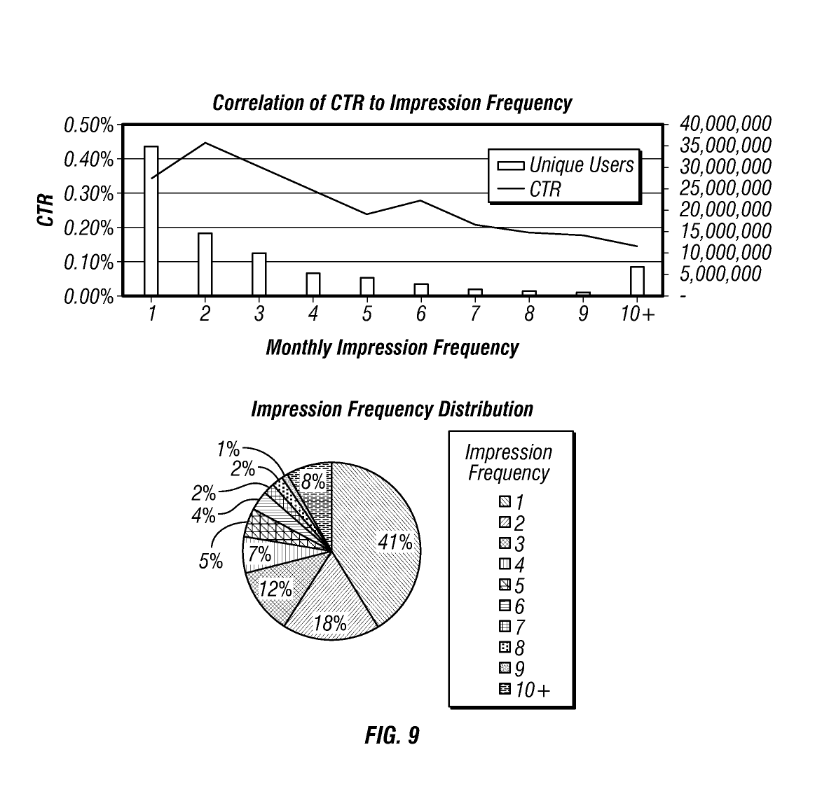

FIG. 9 is a graphic representation of user impression frequency within a unified data management platform based upon the query language established in the dialog of FIG. 8.

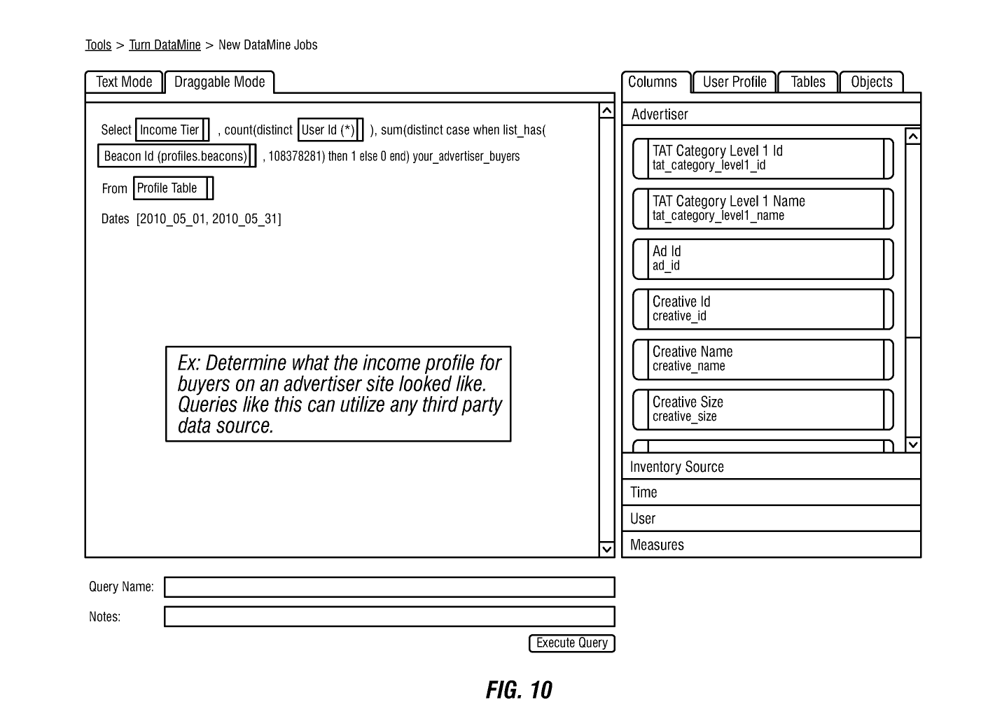

FIG. 10 is a screen diagram showing income skews within a unified data management platform according to an embodiment of the invention. As with FIG. 10, the user has entered into a rule generation dialog, in this case for buyer income profiles.

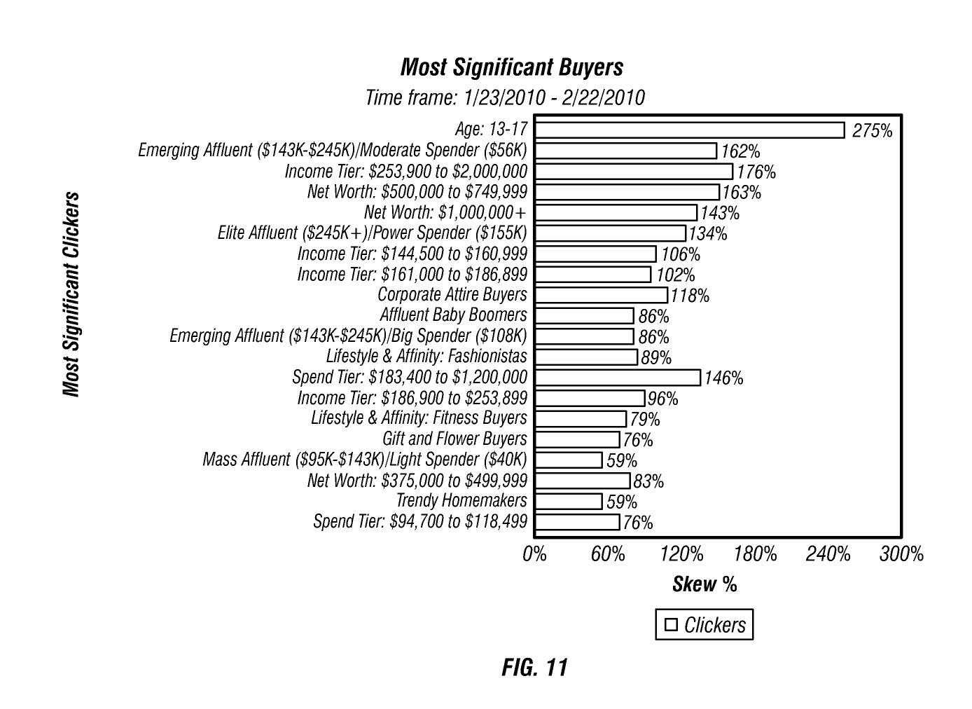

FIG. 11 is a graphic representation of discovering actionable insights within a unified data management platform, in this example, the income skews determined in accordance with the query results generated in the query dialog of FIG. 10.

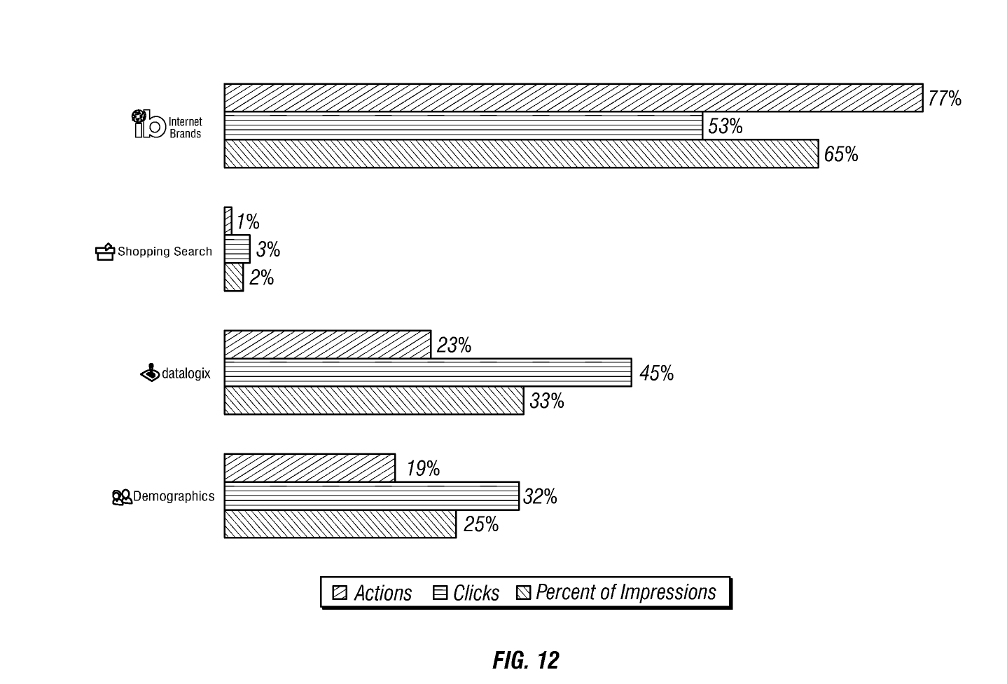

FIG. 12 is a graphic representation of data attribution within a unified data management platform according to an embodiment of the invention. A rule was generated as per the dialog shown in FIGS. 9 and 11 but, in this case, the data was selected from the various profiles described in connection with FIG. 5 above to show data attribution. This report is determined by keeping track of all the data sources used in targeting for each ad impression. For each impression, and the ensuing click or action, all the data sources involved in targeting this impression are given even split of the credit. Based on this even allocation model, the total number of impressions, clicks and actions are then aggregated to the data source level to generate this report.

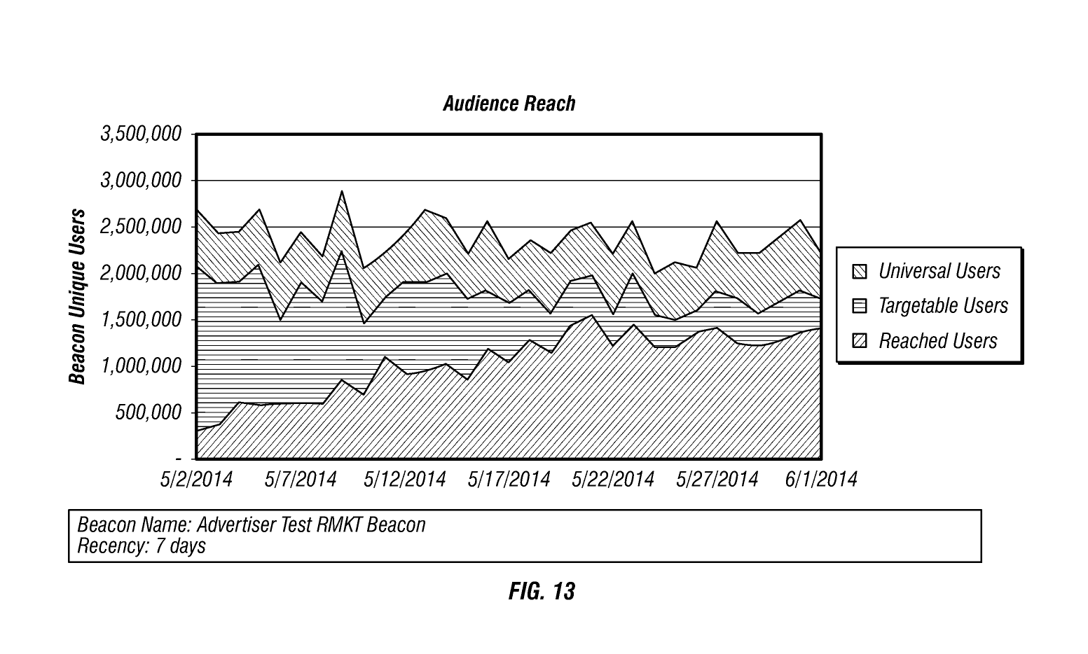

FIG. 13 is a graph showing audience reach as determined with a unified data management platform according to an embodiment of the invention. This is an example of the type of report that can be generated in accordance with the data management platform herein disclosed. The report of FIG. 7 was generated by the Data Mine through querying the analytical user profile store based on the filtering condition of users having the indicated remarketing beacon (Universal Users), users also having any impressions in the system (Targetable Users), and users also having been actually targeted by the system on behalf of this advertiser (Reached Users).

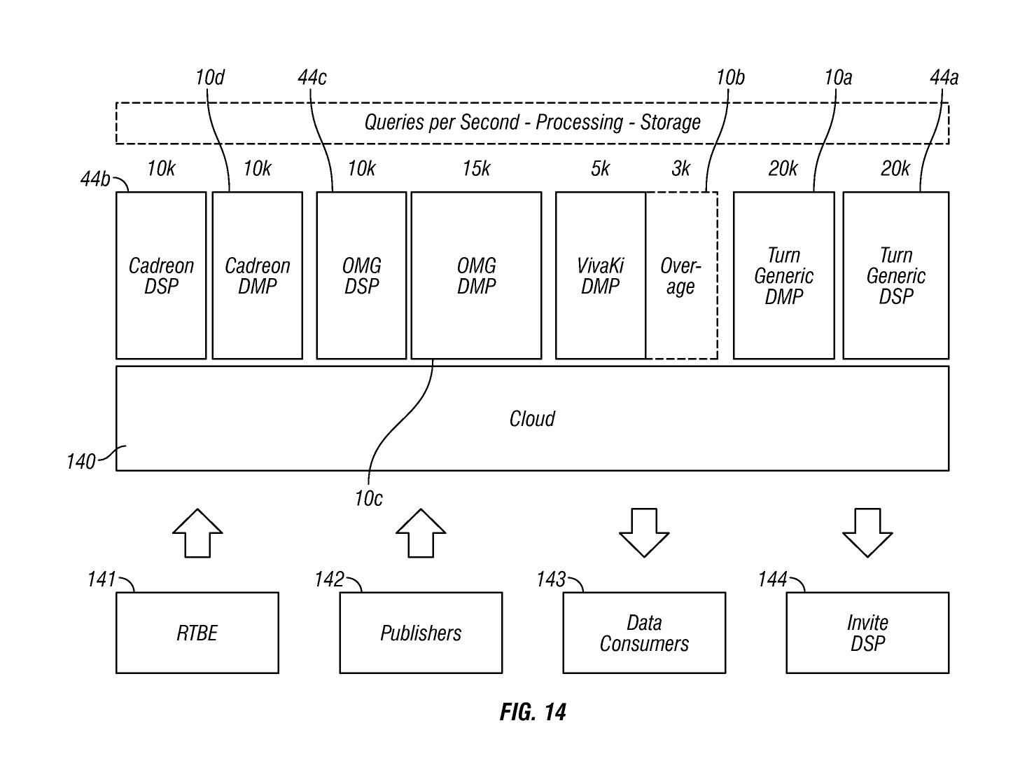

FIG. 14 is a block schematic diagram showing data pathways within a unified data management platform according to an embodiment of the invention. In FIG. 14, an aggregated data management warehouse or cloud 140 includes both a plurality of DSPs 44a-44c and a plurality of DMPs 10a-10d. Data is entered into the cloud in this example via a real time bidding exchange 141 (RTBE) and various data publishers 142. Data is accessed for reporting and other intelligence purposes by other advertising companies, i.e. data consumers 143 and invited DSPs 144. FIG. 14 shows a processing balance mechanism where processing and storage of queries is expressed in queries per second (QPS). In this example, QPS is a metric of processing throughput of concurrent requests. DSPs and DMPs running on private domains will have pre-allocated QPS bandwidth to operate within. In this example, the VivaKi DMP 10b is shown with an overage of bandwidth that can be temporarily accommodated by the system with possibly an additional financial charge agreed upon by the client and the host of the cloud.

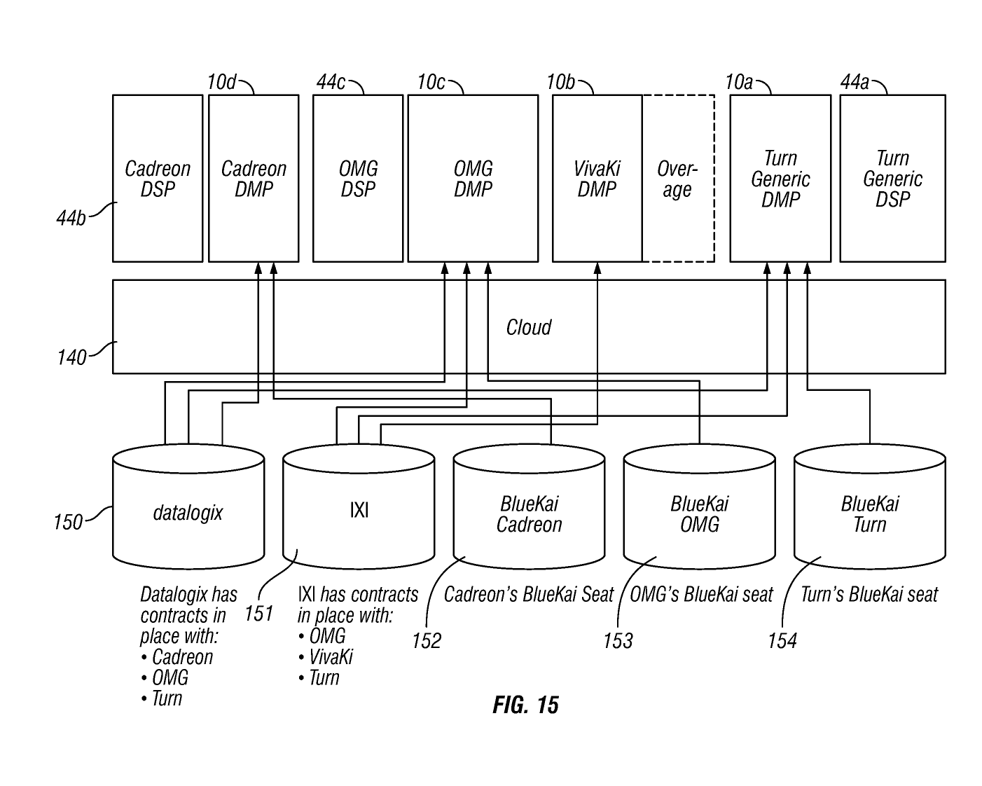

FIG. 15 is a further block schematic diagram showing data pathways within a unified data management platform according to an embodiment of the invention.

In FIG. 15, a plurality of third party data providers and consumers are shown, i.e. Datalogix 150, IXI 151, BlueKai Cadreon 152, BlueKai OMG 153, and BlueKai Turn 154. The differently colored data pathways illustrate how each data set is contractually available to be used by one or more DMPs or DSPs. This permission management is accommodated by the unified data management platform.

Cross-Media Performance Attribution

Attribution or attribution analysis in this section all refer to cross-media performance attribution.

### DEFINITIONS

Touch point=any interaction with the consumer.
Attributes=the specifics of a touch point to analyze.
Variables=the machine readable form of the attributes, for example each inventory source is encoded into a variable, e.g. Y=the outcome to attribute, for example a purchase.

The attribution process builds bootstrapped decision tree models (also known as the “Random Forest” model) or bootstrapped logistic regression models. The contribution of each variable is the total contribution of the variable across all bootstrapped models. In the Random Forest model, variable contribution is the summation of variable contribution in each of the trees. In the bootstrapped logistic regression model, the variable contribution is the average of coefficients across models including zeros when the variable is not used by a model. The totality of the outcome can then be attributed to each variable based on their contribution calculated in such a fashion. For example, attributing all the desired outcome to each inventory source.

Attribution, in a presently preferred embodiment of the invention, encompasses the main uses case of attributing the desired advertising outcome to user touch points occurred at various media channels or certain attributes of these touch points for performance measurement and optimization. Currently, this is done by a “last-ad-win” model, i.e. the last click or ad view by the user before they made purchase is attributed 100% of the credit. In the exemplary model (discussed below), attribution is expanded to include multiple touch points with the user, and assigns the credit with either subjective assignment (1^{st} part) or data driven analytics (2^{nd} part). Both approaches are supported by the data management system disclosed herein.

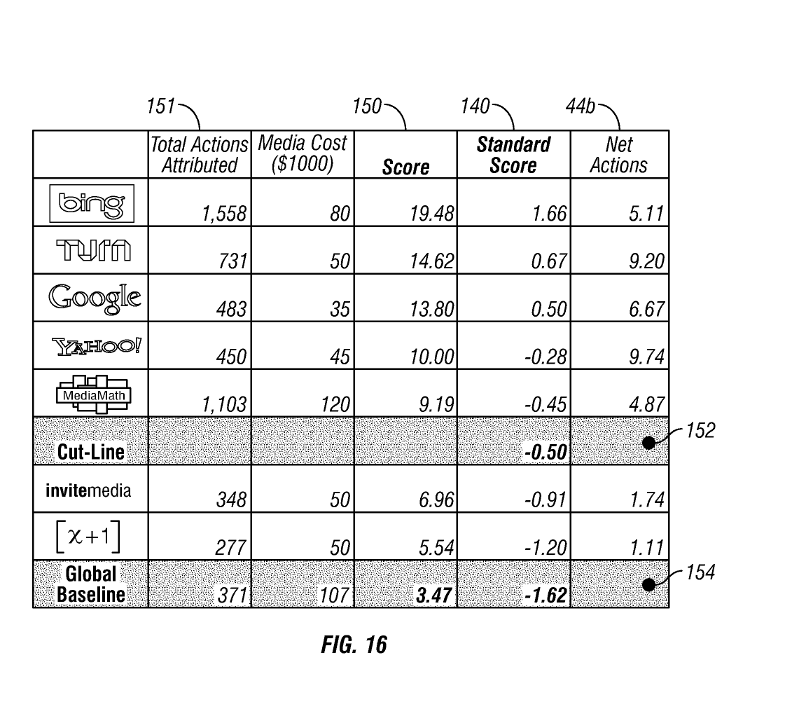

One user case of attribution is to manage the performance of a digital ad campaign using multiple media buying channels, including search ads, display DSPs, Ad networks, Exchanges, Vertical guaranteed media buys, etc. FIG. 16 is a graphic representation showing attribution analysis according to an embodiment of the invention. This embodiment determines how effective each channel is by using full funnel attribution analysis. Thus, this embodiment goes beyond the highly flawed “last-ad-win” model. In this embodiment, attribution analysis is performed as part of data platform, for example by adding tracking pixels to various creatives, landing pages, and conversion pages. An aspect of attribution as taught herein involves subjective attribution analysis in which clients define the value of different types of touch points. The system then aggregates the total value of these touch points. A further aspect of attribution as taught herein involves data driven attribution analysis, in which automated attribution analysis is performed, based on statistical modeling.

In FIG. 16, the attribution model 161 is based upon total action attributed. A performance indicator 160 displays contribution, for example, per $1 k of media, although the value of contribution per dollars of media can be chosen as desired. A standardized score 162 is presented which, in this example, shows a score of −1.0 as being one σ below average and a score of 1.0 as being one σ above average. The user is presented with “what-if” scenarios 163 if the media is dropped. Cut channels 165 with more than 0.5. σ below average are shown, as are global baseline 164 values, i.e. values that would be achieved without any thought or effort given.

In subjective attribution analysis, ad impressions are categorized into critical touch points, for example, as follows:
Introducer: ads within most recent bucket before first visit to brand site;
Engager: any ad that is being clicked by the user;
Influencer: ads within most recent bucket before another visit to brand site; and
Closer: ads within most recent bucket before conversion (click>view).

Recency buckets can be in increments, such as 0-1 hr, 2-3 hr, 4-6 hr, 7-12 hr, 13-24 hr, 2-3 day, 4-7 day, 8-14 day.

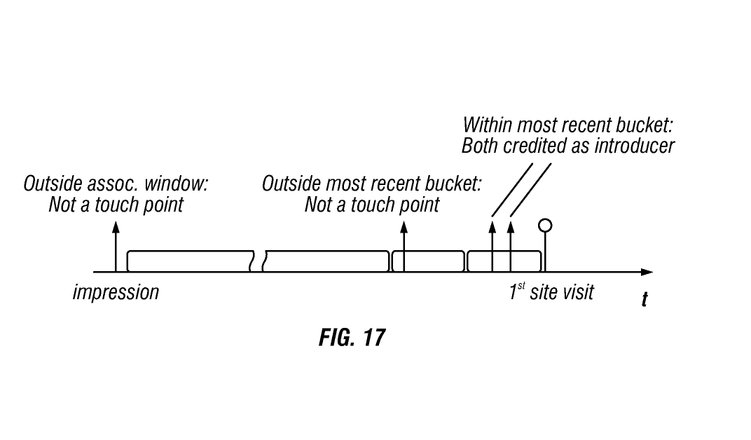

FIG. 17 is a time line showing an association window according to an embodiment of the invention. In FIG. 17, a campaign-specific window is shown for a 7 day increment, where impressions outside of the association window are not taken into accounts as touch points, and where impressions outside of the most recent bucket are not touch points. Thus, in FIG. 17, two impressions which occur before a first site visit during a recent bucket are both credited as introducer touch points.

In this embodiment, customers assign a point value to each type of touch point. For example, in a flat point scheme: introducer=engager=influencer=closer=0.25 point; and in a customized scheme, for example: {0.2, 0.2, 0.2, 0.4}, {0.3, 0.1, 0.1, 0.5}, etc.

The user then picks an analysis dimension, for example inventory source (publishers, exchanges).

An attribution score of inventory source is determined, e.g.

Score(source)=Total Points(source)/Media Spent(source)

The score shows the contribution per $1K spent of each source. This shows the efficiency of each inventory source.

The user may analyze any new dimension, for example by aggregation and decomposing scores along the new dimension.

In data-driven attribution analysis, a modeling equation is applied:

y=f(x₁,x₂, . . . ,xₙ)

Where y is the outcome, xᵢ the attributes of each touch point.

Mathematically,

$$\frac{\partial y}{\partial {x}_{i}}$$

indicates the contribution of xᵢ.

In an embodiment, a logistic regression comprises a linear model, the derivative

$$\frac{\partial y}{\partial {x}_{i}} = {α}_{i }$$

coefficient of xᵢ.

More specifically, αᵢ is the contribution to log odds

$$log ( \frac{y}{1 - y} )$$

where αᵢ is the attribution score for xᵢ.

If X's are not independent, coefficients of a single logistic regression model are subject to the masking effect and do not truthfully reflect X's real-world contribution to the outcome. To solve this problem, attribution analysis is performed in this embodiment with a bootstrapping process of building a collection of logistic regression models each constructed with a random subset of variables and random subset of data. Each model is built to learn a small piece of the underlying advertising data set. This technique allows the system to always get reliable results even when some X's are statistically correlated. The contribution of each variable is computed as the average logistic regression coefficients across all models in the collection. When the variable is not chosen by a model due to random selection, the coefficient of that variable for that model is treated as zero.

Another aspect of attribution involves attribution with bootstrapping (also called bagging) of decision tree models. In this aspect of the invention, a large collection of decision tree models is built. It is also known as the Random Forest model in the literature. Again, each model is built to learn a small piece of the data, and each model is built with a random subset of variables and a sample of data. The outcome is derived by averaging over the prediction of all the models. This approach is suitable for attribution analysis and trades computation for accuracy and stability. Here, aggregate variable contribution across all models provides a stable result. The building process, e.g. bootstrapping or bagging, ensures correlated variables are handled correctly.

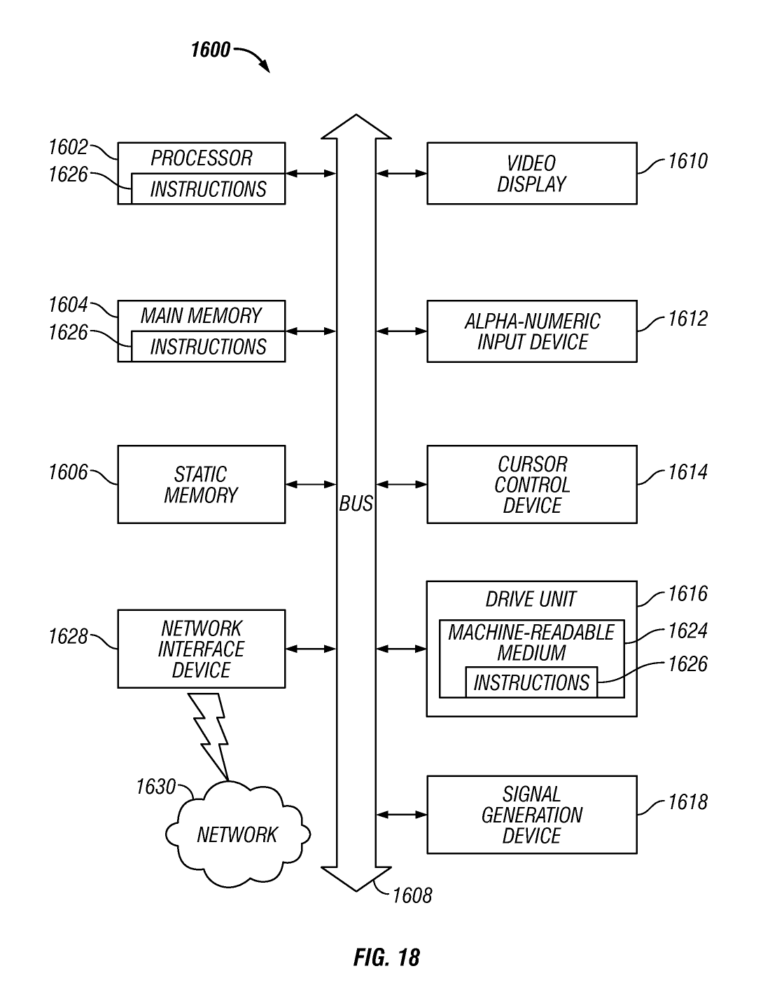

FIG. 18 is a block schematic diagram of a machine in the exemplary form of a computer system 1600 within which a set of instructions for causing the machine to perform any one of the foregoing methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608.

The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with complementary metal oxide semiconductor (CMOS), transistor-transistor logic (TTL), very large systems integration (VLSI), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A unified system for overall on-line advertising management, comprising:
a data management module configured to provide a plurality of facilities, said facilities comprising any of:
a matching formats facility, including pixel-based facilities, a GUID list, and an IP address list;
a data typing facility, including offline demographics/psychological profiles, transactional data, keyword, data, social graph topics, and advertiser CRM information;
a conflict rules facility, including customizable rules for overlapping data, including most trusted data, majority vote data, rules for discarding conflicts, and rules for keeping all data;
a data permissions facility, including customizable rules which are configurable to include all agencies, agency only, advertiser only, and IO only sources; and
a contract types facility, including UU CPM, usage CPM, UU CPM+usage CPM, flat fee, and cost per stamp based accounting;
a data usage module configured to provide functionality for joining multiple sources, manual and algorithmic segment construction, data discovery, real-time analysis of event-level data, a hardware scalable, geo-distributed profile store, and private domain support; and
a reporting and analytics module configured to provide functionality for third party performance data imports, campaign reporting, data usage reporting, audience insights, transaction-level data warehousing, and API connectivity, said reporting and analytics module comprising a plurality of applications, said applications comprising any of:
a campaign reporting application configured to provide performance reporting, third party ad server data integration, and system-of-record reporting;
an audience insights application configured to provide profiles of a brand's performance, multiple dimensions, including age, gender, income, lifestyle, and affinity, and CMO-friendly presentation facilities; and
a data usage reporting application configured to provide agency reporting, including performance by data vendor and data vendor reporting, including data performance by advertiser category;
a transactional level data warehouse in communication with said data management module, data usage module, and reporting and analytics module; and
an API module configured to facilitate information exchange between said reporting and analytics module applications and said data warehouse.

2. A computer implemented method for centralized, overall on-line advertising management in a unitary system comprising a data management platform (DMP) and a plurality of demand side platforms (DSPs), data providers, and advertisers, the method comprising the steps of:
at least one of said DSPs obtaining segments to target;
at least one of said data providers sending user data to said DMP;
said at least one of said DSPs sending impression and click data to said DMP via pixel calls;
said data provider sending user data to said DMP; and
at least one of said advertisers sending user data to said DMP.

3. The method of claim 2, said step of said DSPs obtaining segments to target further comprising the step of:
implementing a container tag fire, wherein said DSP calls said DMP to retrieve data about a user and provides a DSP ID (Media Provider ID) and user ID (DSP's user ID).

4. The method of claim 2, said step of said DSPs obtaining segments to target further comprising the steps of:
said DSP sending a base pixel fire to said DMP; and
said DMP responding with a list of segments that a user matches.

5. The method of claim 2, said step of said data provider sending user data to the DMP further comprising the steps of:
said data provider sending an impression pixel fire to said DMP; and
said DSP providing impression data to said DMP, including user ID, advertiser ID, and segment ID data.

6. The method of claim 2, said step of said DSP sending impression and click data to the DMP via pixel calls further comprises the steps of:
said DSP sending a click pixel fire to said DMP; and
said DSP providing click data to said DMP, including user ID, advertiser ID, and segment ID data.

7. The method of claim 2, said step of said data provider sending user data to said DMP further comprising the steps of:
said data provider sending a pixel to said DMP; and
said data provider calling said DMP with user level data.

8. The method of claim 2, said step of said advertisers sending user data to said DMP further comprising the step of:
sending advertiser data to said DMP to enable conversion events, other page visits, and CRM data.

9. A centralized, overall on-line advertising data management platform (DMP) in communication with a plurality of demand side platforms (DSPs), data providers, and advertisers, comprising:
a runtime user profile; and
an analytic user profile;
wherein said DSPs are configured for ad serving;
wherein said DSPs receive data from pixel-based partners, file-based partners, and end users;
wherein said DSP serves as a point of collection for said data and, in turn, populates said runtime user profile with any of partner event and keyword data, demographic data, impressions or clicks, and Beacon impressions;
wherein said DSP populates said analytic user profile with any of partner event and keyword data, demographic data, impressions or clicks which are stored in an impression click store, and Beacon impressions which are stored in a Beacon impression store;
wherein said DMP receives data from pixel-based data providers, file-based data providers, pixel-based media providers, file-based media providers, and DMP users;
wherein said data providers route third party data and/or advertiser data to said DMP, said pixel-based media providers route container tag fires and impressions or clicks to said DMP and receive matching segment information from said DMP; said file-based media providers route clicks or impression to said DMP; and DMP users send reporting requests to said DMP and receive reporting responses in reply thereto;
wherein said runtime user profile comprises:
a DSP component, which includes any of impressions, clicks, Beacons, segments, partner event data, partner keyword data, and demographic data;
a DMP component, which includes any of media provider impressions, media provider clicks, contract event data, including third party and advertiser specific data, and contract keyword data, including third party and advertiser specific data; and
a shared component, which includes any of IP address, operating system, browser, and screen resolution information;
wherein said analytic user profiles comprises:
a DSP component, which includes any of impressions, clicks, Beacons, segments, partner event data, partner keyword data, and demographic data;
a DMP component, which includes any of media provider impressions, media provider clicks, contract event data, including third party and advertiser specific data, and contract keyword data, including third party and advertiser specific data, and container tag fires, attributed impressions, and attributed clicks; and
a shared component, which includes any of IP address, operating system, browser, and screen resolution information.

10. A unified data management platform (DMP) for managing digital advertising data, said digital advertising data comprising third party vendor data, advertiser and customer relationship management (CRM) data, and advertising and activities from a demand side platform (DSP), said DMP comprising:
one or more modules that are configured to receive real-time data comprising any of pixel-based data, log-file GUID keyed data, and log-file other keys;
a cleansing rules module for processing said real-time data;
a distributed real-time profile storage facility for receiving said real-time data from said cleansing rules module;
a geo-synchronization to other co-los module;
a best data rule-set for producing best data from said real-time data;
a rules module for user level segmentation and zip or IP level segmentation for receiving said best data;
an API module for receiving data output from said rules module.
a facility for synchronizing said real-time data with one or more data warehousing components.

11. The method of claim 10, wherein said data warehouse components comprise:
a module configured for importing custom third party reporting;
a data import API;
a distributed data warehousing module; and
one or more production reporting and contract management modules configured to provide reports to a reporting API layer module.

12. The method of claim 11, wherein said one or more production reporting and contract management modules are configured to provide any of user impression frequency, income skews, data attribution, and audience reach.

13. A data management platform configured to provide a centralized advertising environment, comprising:
a module configured to receive as an input user and audience data;
a module configured to provide intelligence management, self-service user features, forecasting and availability by media channel and provider;
a module configured to provide real time evaluation of segments, best media and channel mix for best return on investment optimization;
a module configured to provide customer defined advanced analytic models for real time scoring, contract management including flexible models and multiple pricing types, customer driver attribution models and optimization; and
said data management platform configured to provide horizontally scalable real time profiles and modules to integrate all environment information to provide reporting, insights, and analytics.

14. The data management platform of claim 13, wherein said module configured to receive as an input user and audience data, receives data comprising any of pixels, log files, mobile information, and television data.

15. The data management platform of claim 13, further comprising:
said data management platform configured to provide cross channel advertising communications to digital, mobile, IP television, and out-of-the-home presentation devices.

16. The data management platform of claim 13, further comprising:
said data management platform configured to provide full ownership, self-service access to, and use of, said information in a client domain.

17. A data management platform for a centralized advertising environment, comprising:
a processor configured to determine cross-media performance attribution;
said processor configured to attribute a desired advertising outcome to either of a plurality of user touch points, which touch points comprise interaction with a consumer that occur at various media channels, and certain attributes of said touch points, which attributes comprise specifics of a touch point;
said processor configured to analyze said touch points and attributes thereof for performance measurement and optimization by building either bootstrapped decision tree models or bootstrapped logistic regression models therefrom;
wherein each of a plurality of variables comprises a machine readable form of an attribute;
wherein each variable's contribution comprises a total contribution of said variable across all bootstrapped models;
wherein in said bootstrapped decision tree model variable contribution comprises a summation of variable contribution in each of said trees;
wherein in said bootstrapped logistic regression model variable contribution comprises an average of coefficients across models, including zeros when said variable is not used by a model; and
wherein outcome totality is attributed to each variable based on said variable's calculated contribution.

18. The data management platform of claim 17, further comprising:
said processor configured to determine how effective each of a plurality of advertising channels is by using full funnel attribution analysis.

19. The data management platform of claim 17, further comprising:
said processor configured to add tracking pixels to various creatives, landing pages, and conversion pages.

20. The data management platform of claim 17, further comprising:
said processor configured to perform subjective attribution analysis in which clients define a value of different types of touch points; and
said processor configured to aggregate a total value of said touch points.

21. The data management platform of claim 17, further comprising:
said processor configured to perform data driven attribution analysis, in which automated attribution analysis is performed, based on statistical modeling.

22. The data management platform of claim 20, said subjective attribution analysis further comprising:
said processor configured to categorize ad impressions into critical touch points which comprise:
introducer touch points comprising ads within a most recent bucket before a first visit to a brand site;
engager touch points comprising any ad that is being clicked by a user;
influencer touch points comprising ads within a most recent bucket before another visit to a brand site; and
closer touch points comprising ads within most recent bucket before conversion.

23. The data management platform of claim 17, further comprising:
said processor configured to determine an attribution score of an inventory source:
Score(source)=Total Points(source)/Media Spent(source)
in which said score shows efficiency of each inventory source.

24. The data management platform of claim 21, said data-driven attribution analysis further comprising:
said processor configured to execute a modeling equation:
y=f(x₁,x₂, . . . ,xₙ)
where y is an outcome, xᵢ of attributes of each touch point;
wherein attribution analysis is performed with a bootstrapping process of building a collection of logistic regression models, each constructed with a random subset of variables and random subset of data;
wherein each model is built to learn a small piece of an underlying advertising data set;
wherein a contribution of each variable is computed as average logistic regression coefficients across all models in a collection; and
wherein when a variable is not chosen by a model due to random selection, a coefficient of that variable for that model is treated as zero.

25. The data management platform of claim 17, further comprising:
said processor configured to perform bootstrapping of decision tree models, in which a large collection of decision tree models is built to learn a small piece of data, and each model is built with a random subset of variables and a sample of data;
wherein an outcome is derived by averaging over a prediction of all the models.
